(19) United States
(12) Patent Application Publication
(10) Pub. No.: US 2010/0307407 A1
(43) Pub. Date: Dec. 9, 2010

(54) ROLLER APPLICATOR

(75) Inventors: Dan Dureiko, Cleveland, OH (US); Michael Maczuzak, Bratenahl, OH (US)

Correspondence Address: KRUGLIAK, WILKINS, GRIFFITHS & DOUGHERTY CO, LPA, 4775 MUNSON STREET N.W., P.O. BOX 36963, CANTON, OH, 44735-6963, US

(73) Assignee: SMART INNOVATIVE PRODUCTS, LLC, Cleveland, OH (US)

(21) Appl. No.: 12/745,420

(22) PCT Filed: Dec. 6, 2008
(86) PCT No.: PCT/US08/85767

§ 371 Date: May 28, 2010

Related U.S. Application Data
(60) Provisional application No. 61/012,183, filed on Dec. 7, 2007.

(51) Int. Cl. B05C 1/08

(52) U.S. Cl. 118/258

(57) ABSTRACT

A roller applicator for applying a coating to a surface selectively engages roller covers of varying tolerances, and releases a roller cover by actuation of an ejector. The roller applicator includes a frame. A roller cover support member, a securing member and an ejector are mounted on the frame. The securing member is formed with fingers that expand radially upon longitudinal movement of the securing member along an actuator to apply pressure to the inner surface of a roller cover and engage the roller cover. The ejector collapses the fingers to release the pressure on the inner surface of the roller cover and disengage the roller cover.

### CROSS-REFERENCE TO RELATED APPLICATION

This application claims the benefit of U.S. Provisional Patent Application Serial No. 61/012,183, filed on Dec. 7, 2007.

### BACKGROUND OF THE INVENTION

1. Field of the Invention

The present invention relates generally to a roller applicator for use in applying a coating to a surface, and more particularly to a roller applicator that is capable of easily accepting, retaining and releasing a roller cover.

2. Background Art

Roller applicators are used for applying a coating such as paint, lacquer, adhesives, or other liquids to a surface. In general, a roller applicator includes a roller frame and components that are attached to the frame to enable the applicator to removably accept a roller cover for application and manipulation of the coating. Typically, the roller cover is removed from the applicator after a coating has been applied to a surface, and the cover is then disposed of or replaced. In the prior art, the roller cover is usually removed from the applicator by manually grasping the cover and pulling it off the applicator. Because the roller cover is usually covered with wet paint or other coating substance at the removal stage, the manual removal of a roller cover is often an undesirably messy and/or complicated task.

Solutions in the prior art to make removal of a roller cover a less messy and/or complicated task have included the development of roller applicators that include a mechanism to eject the roller cover, without the need to manually grasp the cover. However, such roller applicators possess certain disadvantages due to the design of prior art ejection mechanisms. For example, the prior art ejection mechanisms are often complex and include many parts, which makes the applicators expensive to produce and increases their susceptibility to failure. In addition, roller covers that are known in the art as standard covers have varying dimensional tolerances due to differences in manufacturing, and some prior art ejection mechanisms are not capable of readily receiving and/or accommodating the varying tolerances between roller cover cores. As a result, roller applicators with such ejection mechanisms may experience a loose fit for some roller covers on the applicator, and an overly tight fit for other roller covers on the applicator, both of which are undesirable.

As a result, a need has existed in the art for a roller applicator that overcomes the disadvantages of prior art roller applicators, and provides an applicator that is capable of easily receiving, retaining and releasing a roller cover, and which is economical to manufacture and is durable.

### BRIEF SUMMARY OF THE INVENTION

An objective of the present invention is to provide a roller applicator that easily accepts and securely retains a roller cover.

Another objective of the present invention is to provide a roller applicator that selectively releases a roller cover easily.

Yet another objective of the present invention is to provide a roller applicator that is economical to manufacture and is durable.

These objectives and others are obtained by the roller applicator of the present invention. In an exemplary embodiment of the invention, the roller applicator includes a frame having a first end and a second end. A roller cover support member is rotatably mounted on the frame adjacent the frame first end for receiving a roller cover, and a handle is mounted to and extends from the frame second end. A securing member is rotatably mounted on the frame adjacent the roller cover support member, and includes a base that is axially moveable with respect to the frame and a plurality of fingers connected to the base for selectively securing the roller cover on the roller applicator. An actuator radially expands the fingers to enable selective engagement of the roller cover, and an ejector is operably connected to the frame for selectively disengaging the fingers from the roller cover.

### BRIEF DESCRIPTION OF THE DRAWINGS

The preferred embodiments of the invention, illustrative of the best mode in which applicants have contemplated applying the principles of the invention, are set forth in the following description and are shown in the drawings, and are particularly and distinctly pointed out and set forth in the appended claims.

FIG. 1 is a front elevational view of an exemplary embodiment of a roller applicator of the present invention in a disengaged position;

FIG. 2 is a front elevational view of the roller applicator shown in FIG. 1, in an engaged position;

FIG. 3 is an exploded perspective view, from an opposing side, of the roller applicator shown in FIGS. 1 and 2;

FIG. 4 is an enlarged perspective view of the securing member of the roller applicator shown in FIGS. 1-3, in an unfolded position; and

FIG. 5 .is a perspective view of the securing member shown in FIG. 4, in a folded position and including an O-ring.

Similar numerals refer to similar parts throughout the drawings.

### DETAILED DESCRIPTION OF THE INVENTION

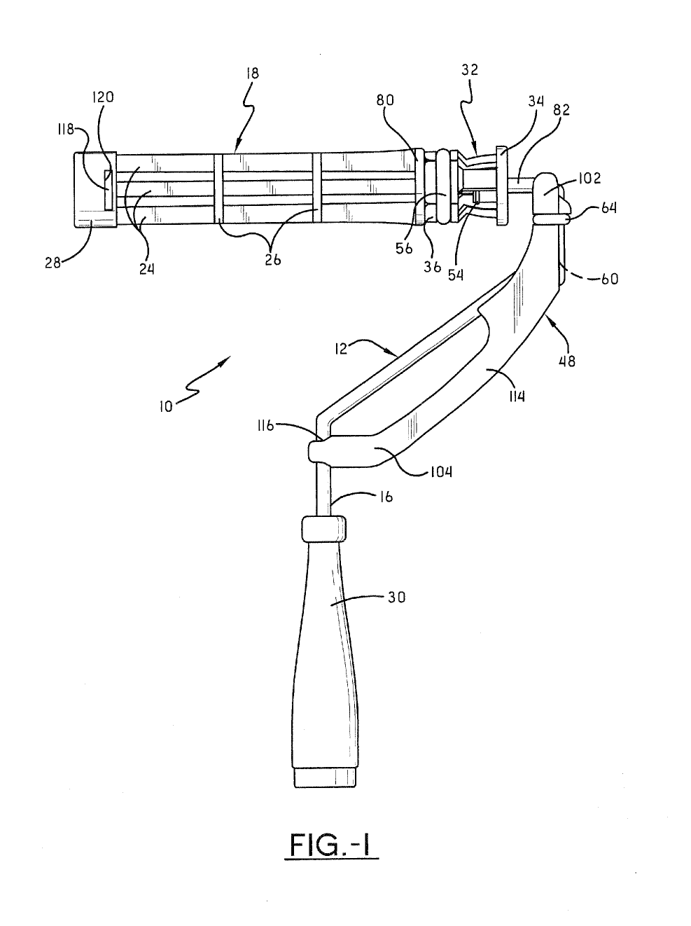

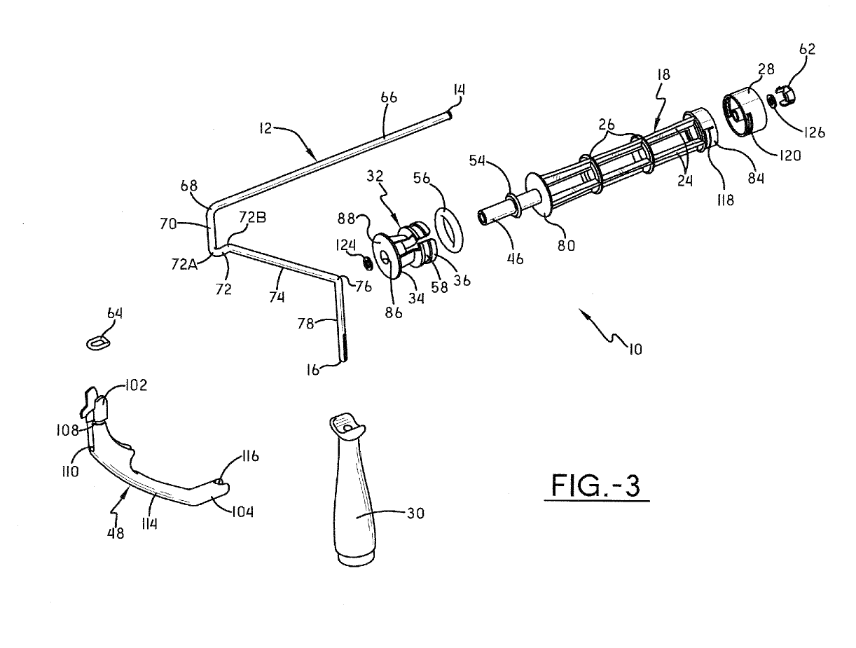

Turning now to the drawings of the present invention, wherein the illustrations are for showing exemplary embodiments of the invention, and not for limiting the same, FIGS. 1-3 show an exemplary embodiment of a roller applicator, indicated generally at 10. Roller applicator 10 accepts a roller cover (not shown) and is used for applying fluid coatings, such as paint, primer and/or sealant, to structural surfaces. Applicator 10 includes a frame 12, on which other components are mounted, as will be described in greater detail below. With particular reference to FIG. 3, frame 12 is a wire or tubular member with a first end 14 and a second end 16, and preferably is constructed from materials such as plastic, metal, wood, or a combination of these materials.

Frame 12 is formed with a plurality of bends between first end 14 and second end 16, which effectively create different portions along the frame. More particularly, frame 12 includes a first or upper portion 66 adjacent first end 14 that extends to a first bend 68, which preferably is about ninety (90) degrees. A frame second portion 70 extends from first bend 68 to a second or compound bend 72. Compound bend 72 includes two bends 72A and 72B, which create a hinge point or rocker point for applicator 10, as will be described in greater detail below. A third frame portion 74 extends in an angular manner from compound bend 72 to a third bend 76, and a fourth or lower frame portion 78 extends from third bend to frame second end 16.

Rigidly attached to frame lower portion 78 at frame second end 16 is a handle 30, which enables a user to grasp roller applicator 10 to move and manipulate the applicator and the associated roller cover. Handle 30 preferably is contoured for convenient and comfortable grasping by a user. Handle 30 may optionally be attached to frame 12 by an adhesive, a weld, an interference fit, a threaded fit, or mechanical fasteners such as a screw, bolt, or rivet, or any other means known in the art. Alternatively, handle 30 may be integrally formed with frame 12, or the handle may be releasably attached to the frame.

Rotatably attached to frame upper portion 66 adjacent first end 14 is a roller cover support member 18, which is also referred to in the art as a cage. Support member 18 receives and supports the roller cover (not shown), and as shown in FIGS. 1-3, rotatably connects to frame 12 in order to enable full rotation of the roller cover about frame upper portion 66. Support member 18 preferably includes a plurality of parallel rods 24 that are spaced apart from one another about the longitudinal axis of frame upper portion 66 when the support member is installed on frame 12. A plurality of longitudinally-spaced struts 26 are connected to each central rod 24 in order to maintain the position and alignment of each rod.

Rod 24 and struts 26 preferably are constructed from material such as plastic, metal, wood, or other generally rigid materials that are known to those skilled in the art. It is to be understood that frame 12 and support member 18 may optionally be formed as an integral unit. It is to be further understood that the aforementioned construction of support member 18 is by way of example, as alternative configurations for the support member may be employed without affecting the overall concept or operation of the present invention.

Extending longitudinally along upper frame portion 66 from an innermost one 80 of struts 26 is a tube 82. Tube 82 preferably is rigidly attached to innermost strut 80, so that the tube and rods 24 of support member 18 selectively move together about upper frame portion 66. Preferably, tube 82 and support member 18 are formed as an integral unit, although they may alternatively be formed as separate components. As shown in FIG. 3, a lock washer 124 preferably is attached to upper frame portion 66 adjacent tube 82 to control longitudinal movement of the inner end of the tube and support member 18. In order to provide an area on frame 12 for lock washer 124 to seat, a crimp or groove (not shown) preferably is formed in upper frame portion 66 adjacent first bend 68.

Attached to an outermost one 84 of struts 26 is an end cap 28, which secures support member 18 on frame 12 to prevent longitudinal movement of the support member at frame first end 14. Outermost strut 84 is optionally formed with a shoulder 118, which interlocks with a slot 120 that is optionally formed in end cap 28. To secure end cap 28 to first end 14 of frame 12, fastening means (not shown), such as an adhesive or a weld, or a mechanical fastener, such as a bolt, a screw, a rivet, a nail, a lug, or a nut may be used with a washer 126 and a cover 62. Preferably, end cap 28 has substantially the same diameter as support member 18, in order to enable a roller cover to pass over the end cap, while also providing support for the roller cover at frame first end 14.

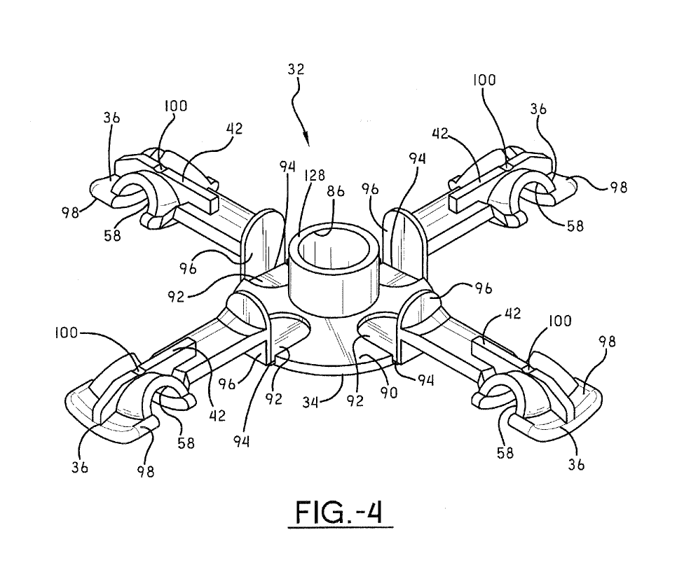

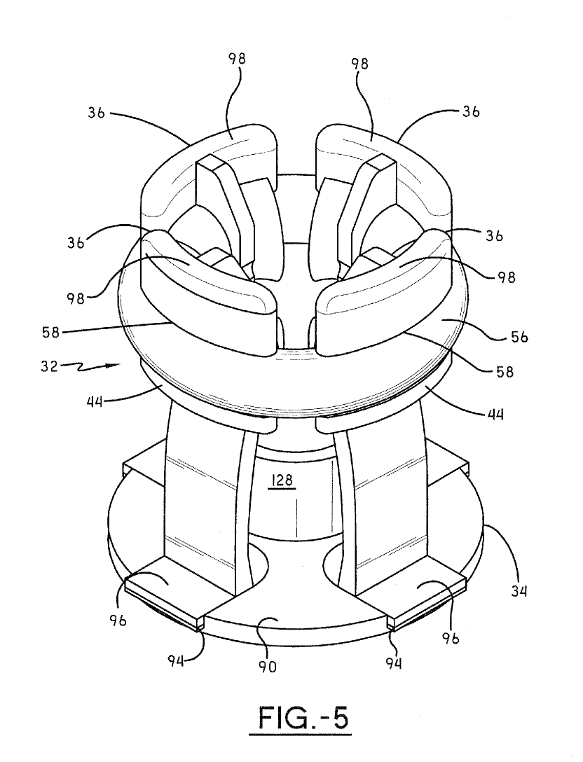

Roller applicator 10 includes a securing member 32, which extends about tube 82 to selectively engage and disengage the core of a roller cover (not shown). Securing member 32 functions to hold the roller cover securely on applicator 10 during use by firmly engaging or expanding against an interior surface of the roller cover core. More particularly, with reference to FIGS. 4 and 5, securing member 32 includes a base 34 and a plurality of fingers 36 that are flexibly connected to the base, and which are capable of expanding to enable the securing member to grip the core of the roller cover by applying radial pressure or force to the inner surface of the roller cover core.

In order to enable cost-effective manufacturing, base 34 and fingers 36 preferably are formed as an integral component. Alternatively, base 34 and fingers 36 may be formed as separate components and then joined or connected. Base 34 includes a tube 128 having an opening 86 that enables securing member to slide onto tube 82. Preferably, an inner surface 90 of base 34 is formed with recesses 92 that enable a base end 96 of each respective finger 36 to seat firmly on the base, while maintaining a flexible, hinged connection 94. The connection between base end 96 of each respective finger 36 and base 34, including hinge 94, enables securing member 32 to readily expand to engage a roller cover and contract to disengage the roller cover, while also being economically manufactured. Preferably, base 34 and fingers 36 of securing member 32 are constructed from a polymer material, which may be a resiliently deformable or flexible material, including but not limited to polymeric materials such as thermoplastic elastomers, polyurethanes, or other thermoplastic materials.

Each finger 36 includes a distal end 98, and a groove 58 preferably is formed on an exterior surface 44 of each respective finger near the distal end. A resilient member 56, for example, an O-ring, seats in groove 58 in order to draw or collapse fingers 36 together, as shown in FIG. 5. The outer diameter of O-ring 56 is of a sufficient dimension to engage the inner surface of a roller cover core, as will be described in greater detail below. O-ring 56 preferably is formed of an elastomeric or polymeric material, which may be a resiliently deformable or flexible material including, but not limited to, thermoplastic elastomers, polyurethanes, EPDM rubber, or silicone rubber.

It is to be understood that structures other than an O-ring may be used to comprise resilient member 56 without affecting the overall concept or operation of the invention. For example, spring steel may be used to form resilient member 56. In addition, a resilient material may be disposed on or joined to an exterior surface 44 of each respective finger 36 at distal end 98 to form resilient member 56. Such a resilient material includes elastomers, polymers, metals, and combinations thereof. Moreover, resilient member 56 may be formed with features that enable it to engage the inner surface of a roller cover core, as will be described below. For the purpose of convenience, reference herein shall be made to resilient member 56 as an O-ring, with the understanding that the resilient member includes such other forms and/or structures.

Fingers 36 taper, curve or are angled inwardly from base end 96 of securing member 32 to distal end 98 when O-ring 56 draws them together. Preferably, each finger 36 is formed with an interior surface 42 that is angled or sloped from base end 96 to distal end 98. This configuration enables fingers 36 to slide over and along an actuator or disc 54 (FIG. 3) that is formed on and extends radially outwardly from tube 82 when securing member 32 moves longitudinally along the tube. As fingers 36 slide longitudinally over disc 54 from each of their respective base ends 96 toward their distal ends 98, interior surface 42 of each finger functions as a cam to engage the disk, which enables the fingers to expand radially outwardly. When securing member 32 has moved a sufficient longitudinal distance along tube 82, a notch 100 that is formed on interior surface 42 of each respective finger 36 near distal end 98 engages and seats on disk 54. The engagement of each notch 100 on disk 54 secures the expanded or radial position of fingers 36.

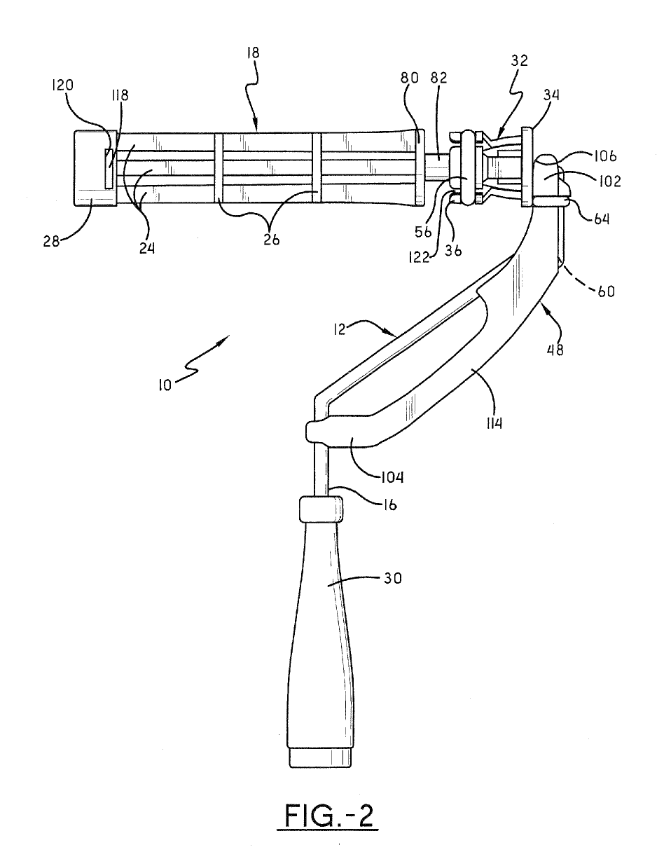

More particularly, returning now to FIG. 1, fingers 36 of securing member 32 are drawn together by O-ring 56 when a roller cover is not installed on roller applicator 10. When fingers 36 are drawn together, distal end 98 is of a smaller outer diameter than the outer diameter of base 34 when securing member 32 is in the neutral or disengaged position. This position of fingers 36 enables a roller cover to be placed over end cap 28 and over support member 18. Turning to FIG. 2, as the roller cover is moved along support member 18 toward ejector 48, it reaches securing member 32. The inner surface of the roller cover slides over fingers 36 and O-ring 56 of securing member 32 until it contacts securing member base 34. which has an outer diameter that is greater than the roller core inner diameter. The contact of the roller cover with base 34 causes securing member 32 to move longitudinally along upper frame portion 66 (FIG. 3) and tube 82 toward an ejector 48. As securing member 32 moves along tube 82, fingers 36 slide longitudinally over disc 54 toward ejector 48, which causes distal end 98 of each finger to expand radially outwardly by way of cam actuation until notches 100 engage the disc.

Once notches 100 engage disc 54, securing member 32 is in an engaged position, as shown in FIG. 2. In the engaged position, the radial expansion of distal end 98 (FIG. 3) of fingers 36 causes the finger to be spread apart from one another, as shown by a gap 122 between them. This expansion of distal end 98 of fingers 36 causes a force or pressure to be exerted against the inner surface of the roller cover core by O-ring 56. This force or pressure holds the roller cover securely onto securing member 32 and support member 18. In this position, fingers 36 and O-ring 56 distribute the pressure evenly around the inside diameter of the roller cover to prevent distortion of the roller cover and enable even movement of the roller cover against the surface upon which the coating is being applied.

It is to be understood that resilient member 56 preferably has a different coefficient of friction than fingers 36, which enables additional frictional forces to hold the roller cover securely in place. It is to be further understood that disk 54 preferably is integrally formed with tube 82, and alternatively, may be formed as a separate component that is placed on or joined to the tube.

To disengage the roller cover from roller applicator 10, ejector 48 is actuated by a user. More particularly, ejector 48 includes an upper end 102 and a lower end 104. Upper end 102 includes a contact point 106 that is adjacent an outer surface 88 (FIG. 3) of securing member base 34 when roller applicator 10 is in an engaged position, as shown in FIG. 2. A contoured ejector handle 114 is formed adjacent lower end 104, enabling the user to easily grasp ejector 48 and to provide sufficient leverage to actuate securing member 32.

When a user grasps ejector handle 114 and pulls it away from frame 12, ejector upper end 102 and contact point 106 pivot toward frame first end 14 (FIG. 3), which urges securing member 32 along the longitudinal axis of frame upper portion 66 toward support member 18. As securing member 32 moves toward support member 18, notches 100 of fingers 36 disengage from disk 54. The disengagement of notches 100 from disk 54 enables O-ring 56 to draw fingers 36 together. This drawing action from O-ring 56 cooperates with angled interior surface 42 of each finger 36, so that the interior surface of each respective linger slides along disk 54 and urges securing member 32 toward support member 18. As securing member 32 continues to slide toward support member 18, fingers 36 contract and return to the neutral or disengaged position shown in FIG. 1. As fingers 36 contract, the applied force or pressure between O-ring 56 and the inner surface of the roller cover core decreases to release the roller cover. The release of pressure on the roller cover core, combined with the movement of securing member 32 toward support member 18 ejects the roller cover off of the securing member and the support member. After such actuation of ejector 48 and ejection of the roller cover, securing member 32 preferably returns to a disengaged position to accept a new roller cover.

The movement of ejector upper end 102 upon actuation of ejector handle 114 is enabled by a pivot point or rocker point 60, as shown in FIGS. 1 and 2. More particularly, with additional reference to FIG. 3, ejector 48 is formed with an opening 110, which enables frame 12 to pass through the ejector so that the ejector seats on compound bend 72. Once ejector 48 is seated on compound bend 72, pivot point 60 is formed. Thus, when ejector handle 114 is pulled away from frame 12, compound bend 72 supports ejector 48 at opening 110, which enables pivotal movement of the ejector at pivot point 60. This pivotal movement at pivot point 60 in turn enables upper end 102 of ejector 48 to move toward frame first end 14, as described above.

In order to return ejector 48 to a neutral or non-actuating position and maintain that position during use of roller applicator 10, the ejector is formed with a groove 108 that receives a resilient member 64 such as an O-ring. O-ring 64 connects ejector upper end 102 to frame second portion 70. Thus, when upper end 102 pivots toward frame first end 14 and away from frame second portion 70, O-ring 64 urges the ejector upper end back to the frame second portion. O-ring 64 preferably is constructed from elastic, resilient material, such as an elastomer or a thermoplastic elastomer.

It is to be understood that structures other than an O-ring may be used to comprise resilient member 64 without affecting the overall concept or operation of the invention. For example, spring steel may be used to form resilient member 64. In addition, resilient member 64 may be constructed in alternative manners. For example, resilient member 64 may be a spring steel member that is mounted at one end to frame second portion 70 and at another end to ejector 48 below pivot point 60. In such a case, by extending between frame second portion 70 and ejector 48, spring steel resilient member 64 biases the ejector to a closed position. In this manner, alternative forms for resilient member 64 may be employed, all of which return ejector 48 to a closed position after it has been actuated. For the purpose of convenience, reference herein has been made to resilient member 64 as an O-ring, with the understanding that the resilient member includes such other forms and structures.

In order to enable ejector 48 to align with frame 12 and seat securely on the frame during use of roller applicator 10, ejector lower end 104 is optionally formed with a slot 116 that engages frame lower portion 78. It is to be understood that ejector 48 may be constructed of rigid or semi-rigid material such as plastic, wood, metal, or a combination of these materials.

In this manner, roller applicator 10 of the present invention provides a roller applicator that easily accepts and securely retains a roller cover. In addition, roller applicator 10 selectively and easily releases the roller cover. Moreover, roller applicator 10 of the present invention provides a robust design with a generally small number of components, which enables the applicator to be economical to manufacture and less susceptible to component failure.

The present invention also includes a method for selectively engaging and releasing a roller cover. The method includes providing a roller applicator having a securing member, and steps in accordance with the description that is presented above and shown in FIGS. 1-5.

It is to understood that, while reference above has been made to certain preferred materials for components of roller applicator 10, other materials known to those skilled in the art may be used without affecting the overall concept or operation of the present invention. In addition, configurations of components for roller applicator 10 other than those described above may be used without affecting the overall concept or operation of the invention. For example, securing member 32 and ejector 48 may move in an opposing direction from that described above, and/or the securing member and support member 18 may rotate independently from one another when roller applicator 10 is in a neutral or disengaged position.

Accordingly, the roller applicator of the present invention is simplified, provides an effective, safe, inexpensive, and efficient structure which achieves all the enumerated objectives, provides for eliminating difficulties encountered with prior-art roller applicators, and solves problems and obtains new results in the art.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the invention is by way of example, and the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved roller applicator is constructed, arranged and used, the characteristics of the construction and arrangement, and the advantageous, new and useful results obtained; the new and useful steps, structures, devices, elements, arrangements, parts and combinations, are set forth in the appended claims.

What is claimed is:

1. A roller applicator for applying a coating to a surface, comprising:
a frame having a first end and a second end;
a roller cover support member rotatably mounted on said frame adjacent said frame first end for receiving a roller cover;
a handle mounted to and extending from said frame second end;
a securing member rotatably mounted on said frame adjacent said roller cover support member, said securing member including a base axially moveable with respect to the frame and a plurality of fingers connected to said base for selectively securing said roller cover on said roller applicator;
an actuator for radially expanding said fingers to enable selective engagement of said roller cover; and
an ejector operably connected to said frame for selectively disengaging said fingers from said roller cover.

2. The roller applicator of claim 1, further comprising a resilient member disposed on said fingers.

3. The roller applicator of claim 2, wherein each one of said fingers is formed with a groove and said resilient member is an O-ring that seats in said grooves.

4. The roller applicator of claim 2, wherein said resilient member is a resilient material disposed on an exterior surface of said fingers.

5. The roller applicator of claim 2, wherein said resilient member includes a different coefficient of friction than said securing member.

6. The roller applicator of claim 1, wherein said actuator is a disk that causes said fingers to expand when said securing member is moved axially with respect to said frame.

7. The roller applicator of claim 6, wherein said fingers are tapered.

8. The roller applicator of claim 6, wherein said fingers are formed with notches to releasably engage said disk.

9. The roller applicator of claim 6, wherein an interior surface of each one of said fingers is angled from its base end to its distal end.

10. The roller applicator of claim 1, wherein said frame is formed with a compound bend.

11. The roller applicator of claim 10, wherein said ejector engages said frame at said compound bend.

12. The roller applicator of claim 11, wherein said ejector is pivotally supported on said frame at said compound bend.

13. The roller applicator of claim 10, further comprising a resilient member connecting said ejector to said frame.

14. The roller applicator of claim 13, wherein said resilient member is an O-ring.

15. The roller applicator of claim 13, wherein said resilient member is a spring steel member.

16. The roller applicator of claim 1, wherein an upper end of said ejector contacts said securing member base to move said securing member longitudinally to disengage said fingers.

17. The roller applicator of claim 1, further comprising an end cap mounted on an end of said roller cover support member.
